(19) United States
(12) Patent Application Publication
(10) Pub. No.: US 2003/0223764 A1
(43) Pub. Date: Dec. 4, 2003

(54) Receiver for diffused infrared wireless communications

(76) Inventors: Yuen Chuen Chan, Singapore (SG); Yee Loy Lam, Singapore (SG)

Correspondence Address: BUCKLEY, MASCHOFF, TALWALKAR, & ALLISON, 5 ELM STREET, NEW CANAAN, CT, 06840, US

(21) Appl. No.: 10/359,480

(22) Filed: Feb. 6, 2003

(30) Foreign Application Priority Data
Feb. 7, 2002 (GB) 0202896.7

(51) Int. Cl. H04B 10/06

(52) U.S. Cl. 398/207

(57) ABSTRACT

The present invention relates to a receiver for an infrared wireless communications system. The receiver comprises: a hot-spot monitoring photodetector array (6); a sensing photodetector array (7); an optical element (5) for splitting a received signal into two parts and focusing each part onto one of the photodector arrays (6, 7); means for monitoring the hot-spot monitoring photodetector array (6); and means for adjusting the response of the sensing photodetector array (7) in response to the detected signal of the hot-spot monitoring photodetector array (6).

### FIELD OF THE INVENTION

Wireless digital links are emerging as a requirement from portability in computing and multimedia terminals in both work and home environments. Infrared (IR) radiation is a promising medium for short range wireless communications. When compared to the ubiquitous RF links, links connected by IR have the advantages of (a) high speed communication, (b) virtually unlimited optical bandwidth, (c) highly secure transmission from signal confinement, (d) no interlink interference, and (e) no multipath fading. On the other hand, there are problems associated with IR wireless transmission such as intense ambient noise from sunlight, incandescent and fluorescent lighting, multipath dispersion, high loss and eye safety requirements.

### BACKGROUND TO THE INVENTION

Wireless IR links can be classified based on the directionality of the receiver and transmitter. A directed system is one that employs narrow field of view (FOV) transceivers that must be aimed at each other to establish a link. This type of line-of-sight (LOS) configuration has been used to link buildings at their rooftops, and high transmission rates have been achieved. However, in an indoor environment, this type of system has limited use since the light beam could be easily blocked, reducing the system's robustness. A non-directed system makes use of wide FOV transceivers that eliminate the need for direct aiming, doing away with the LOS requirement. A non-directed and non-LOS link, otherwise known as a diffused link, is more robust and mobile with a low to medium transmission rate capability. In such a link, the infrared radiation propagates through air along multiple paths of variable lengths via reflections from the walls to the receiver.

Possible configurations of the receivers used in IR wireless systems include the single element receiver, angle-diversity receiver and imaging angle-diversity receiver. The single element receiver suffers from the critical shortcoming of a low signal-to-noise ratio (SNR) capability. This is due to the fact that the signal, ambient light noise, co-channel interference and delayed multipath signals are picked up simultaneously by the photodetector element, leading to a reduction in the SNR. In addition, IR signal on this receiver could also be blocked, resulting in a total loss of signal and therefore its transmission is not guaranteed.

The angle-diversity receiver picks up the light over a wide field-of-view (FOV) and is able to achieve high gain. The effects of ambient noise, co-channel interference and multipath distortion are reduced. Of course, by receiving light over a wide field, the blocking problem is greatly alleviated.

The imaging angle diversity receiver, shown in FIG. 1, overcomes all the above problems by incorporating an optical lens to focus the transmitted signal onto an array of small photodetectors that are placed at the focal plane. Here, each element acts as a directed receiver and subtends a small part of the total FOV. The imaging angle diversity receiver's effective FOV is hence the total FOV subtended by all the elements of the array. By keeping the pixel element small, it is likely that the signal spot and localized noise sources are imaged onto different elements. By picking up the signals at the brightest spot, it is possible to completely reject the various noise sources. An optical filter is placed above the optical lens to cut off the visible component of light so as to reduce the optical noise.

The photodetector array used in the imaging angle diversity receiver could be arranged in a 2D plane, with individual elements in hexagonally shaped p-i-n structures for maximum packing, as shown in FIG. 2. Since the elements are individually addressable and the scene is imaged onto the array, it is possible to locate the hot spots of high intensity signals by interrogating all the photodetector elements. Upon picking up such spots, the related photodetector elements could be monitored for the IR signals, while the other weakly illuminated photodetector elements are switched off. In this way, one is able to reduce drastically the noise associated from random scattering and electrical circuit noise. A possible scheme is to interrogate all the elements in an array, store the signals into a memory, and then scan through the signal matrix to locate the high intensity spots. Once this is achieved, the electronics will then monitor the specific elements with high intensity spots. To account for possible change in the incidence location of the strong intensity spots, the total element scanning must be carried out at a regular frequency, during which there is a lapse of signal pickup. Hence, continuous diffused IR wireless transmission is not possible.

### SUMMARY OF THE INVENTION

According to the present invention, a receiver for an infrared wireless system comprises:

a first photodetector array;

a second photodetector array;

means for splitting a received signal into two parts and focusing each part onto one of the photodector arrays;

means for monitoring the first photodetector array; and

means for adjusting the response of the second photodetector array in response to the detected signal of the first photodetector array.

The configuration of the receiver of the present invention allows for continuous, always-on diffused infrared wireless transmission. The signal is split into two parts, and one part is monitored on the first photodetector array whilst the received signal is detected at the second photodector array. This allows the response of the second photodetector array to be adjusted based on the response of the first photodetector array to eliminate noise without a lapse of signal pickup which occurs during the scanning process in the prior art.

Preferably, the photodetectors are high speed photodetectors such as p-i-n photodiodes or metal-semiconductor-metal photodetectors, allowing the overall transmission to be raised above 100 megabits per second.

Preferably, the means for splitting the receiving signal comprises a diffractive optical element.

Preferably, the receiver also includes an optical filter. The optical filter is placed to cut out the visible components of light from the received signal so as to reduce the optical noise.

Preferably, the signal is split into two substantially identical parts.

Preferably, the means for monitoring the first photodetector array comprises means for detecting peaks in the signal incident on the first photodetector array. This results in locating the positions of the signal on the first photodetector array.

Preferably, the means for adjusting the response of the second photodetector array comprises means for activating or deactivating individual photodetectors in the second photodetector array.

Preferably, photodetectors are activated which correspond to the positions of the peaks detected on the first photodetector array, and the other photodetectors in the second photodetector array are deactivated. Thereby the background noise on the second photodetector array is eliminated and the signal is isolated. An alternative would be to attenuate the response of the photodetectors where a peak is not located.

Preferably, the first photodetector array is continuously scanned to locate the positions of peaks, and the response of the second photodetector array is adjusted accordingly. This allows for movement of the positions of the signal peaks on the photodetector arrays.

### BRIEF DESCRIPTION OF THE DRAWINGS

Examples of the present invention will now be described with reference to the accompanying drawings in which:

FIG. 1 shows a prior art imaging angle diversity receiver;

FIG. 2 shows a photodetector array; and

FIG. 3 shows a receiver in accordance with the present invention.

### DETAILED DESCRIPTION

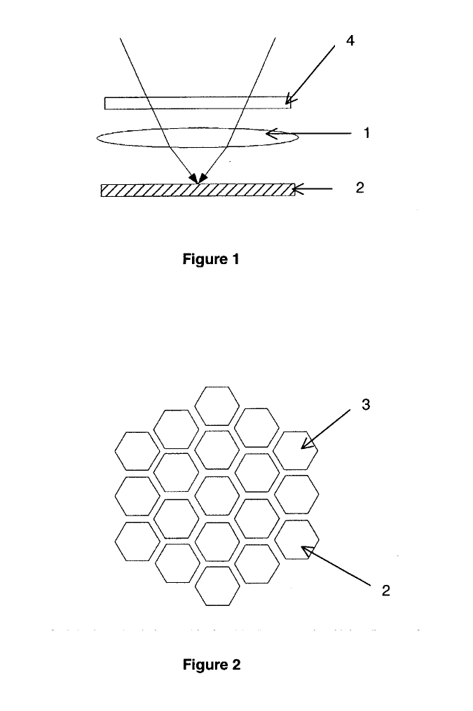

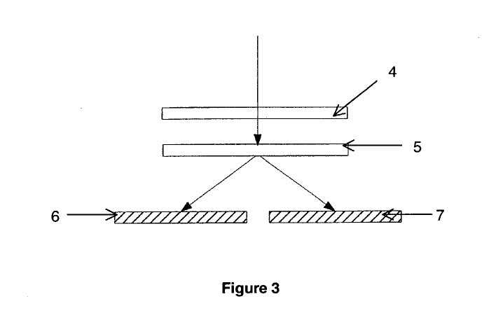

FIG. 1 shows a prior art imaging angle diversity receiver having an optical lens 1 for focusing a received signal onto a photodetector array 2. A suitable photodetector array is illustrated in FIG. 2, and has nineteen hexagonal elements 3, each comprising an individually addressable photodetector. An optical filter 4 is placed above the optical lens 1 to cut off the visible components of light so as to reduce the optical noise. By keeping the pixel element small, it is likely that the signal spot and localised noise sources are imaged onto to different elements. By picking up the signals at the brightest spot, it is possible to completely reject the various noise sources.

FIG. 3 shows the proposed new imaging angle diversity receiver consisting of an optical filter 4, a diffractive optical element 5, a hot-spot monitoring photodetector array 6 and a sensing photodetector array 7. After passing through the optical filter 4, the IR radiation is imaged into two identical parts by the diffractive optical element 5. Two arrays of photodetectors 6, 7 are placed in the focal plane of the two images. Each array is similar to that shown in FIG. 2, and has a number of individually addressable photodetectors 3. In one of the photodetector arrays 6, scanning is carried out to determine the presence and location of hot spots in the image. The main objective here is to sense the signal only at the hot-spots, so as to achieve a high SNR. Upon the determination of the location of the hot spot, the corresponding few elements in the sensing photodetector array 7 are then switched on to receive the signals. The remainder of the elements are switched off. In this way, only the elements of the high intensity illumination are activated for signal sensing.

It should be noted that while the sensing array 7 is receiving the signals, the hot-spot monitoring array 6 is continuously scanning all elements 3 of the array 6 to determine the hot-spots, which may shift due to the movement of the receiving equipment or people in the indoor environment. Upon a complete scan, the sensing array 6 could be tuned to another element so as to always capture high intensity signals. Hence, this new imaging diversity receiver and hence the diffused IR wireless transmission is continuously on, since the functions of hot-spot scanning and sensing are separated and performed by two different photodetector arrays 6, 7.

1. A receiver for an infrared wireless system comprising:
a first photodetector array;
a second photodetector array;
means for splitting a received signal into two parts and focusing each part onto one of the photodector arrays;
means for monitoring the first photodetector array; and
means for adjusting the response of the second photodetector array in response to the detected signal of the first photodetector array.

2. A receiver according to claim 1, wherein the photodetectors are high speed photodetectors such as p-i-n photodiodes or metal-semiconductor-metal photodetectors.

3. A receiver according to claim 1, wherein the means for splitting the receiving signal comprises a diffractive optical element.

4. A receiver according to claim 1, also including an optical filter.

5. A receiver according to claim 1, wherein the signal is split into two substantially identical parts.

6. A receiver according to claim 1, wherein the means for monitoring the first photodetector array comprises means for detecting peaks in the signal incident on the first photodetector array.

7. A receiver according to claim 1, wherein the means for adjusting the response of the second photodetector array comprises means for activating or deactivating individual photodetectors in the second photodetector array.

8. A receiver according to claim 7, wherein photodetectors are activated which correspond to the positions of the peaks detected on the first photodetector array, and the other photodetectors in the second photodetector array are deactivated.

9. A receiver according to claim 1, wherein the first photodetector array is continuously scanned to locate the positions of peaks, and the response of the second photodetector array is adjusted accordingly.
